(19) United States
(12) Patent Application Publication
(10) Pub. No.: US 2002/0182524 A1
(43) Pub. Date: Dec. 5, 2002

(54) Electrophotosensitive material

(76) Inventors: Maki Uchida, Osaka (JP); Hideki Okada, Osaka (JP)

Correspondence Address: SMITH, GAMBRELL & RUSSELL, LLP, 1850 M STREET, N.W., SUITE 800, WASHINGTON, DC, 20036, US

(21) Appl. No.: 10/095,079

(22) Filed: Mar. 12, 2002

(30) Foreign Application Priority Data
Mar. 12, 2001 (JP) 2001-067904

(51) Int. Cl. G03G 5/047; G03G 5/14

(52) U.S. Cl. 430/58.05; 430/59.6; 430/62; 430/63

(57) ABSTRACT

The invention relates to an electrophotosensitive material featuring an intermediate layer interposed between a conductive substrate and a photosensitive layer and containing a binder resin and a charge transport material having a molecular weight of 400 or more. The intermediate layer has a constant thickness because the intermediate layer can be formed by, for example, dip coating a coating solution containing the above two components on the conductive substrate without suffering much flow-down of the coating solution. Hence, overlaying the photosensitive layer on the intermediate layer provides an electrophotosensitive material capable of offering favorable, fog-free images.

### TECHNICAL FIELD

The present invention relates to an electrophotosensitive material comprising a conductive substrate, a photosensitive layer and an intermediate layer (undercoat layer) interposed therebetween.

### BACKGROUND OF THE INVENTION

As an electrophotosensitive material for use in image forming apparatuses such as electrostatic copiers, plain paper facsimiles, laser beam printers and composite machines incorporating these functions, a so-called organic electrophotosensitive material is widespread which comprises a combination of the following components:

a charge generating material for generating electric charges (positive hole and electron) when exposed to light;

a charge transport material for transporting the generated electric charges; and

a binder resin.

The charge transport materials fall into two broad categories which include a hole transport material for transporting positive holes of the electric charges, and an electron transport material for transporting electrons.

The organic electrophotosensitive material has an advantage over an inorganic electrophotosensitive material employing an inorganic semiconductor material in that the organic electrophotosensitive material is fabricated more easily at less production costs than the latter.

In addition, the organic electrophotosensitive material also has a merit of greater freedom of function design by virtue of a wide variety of options for materials including those described above.

In this connection, the organic electrophotosensitive materials have recently been widely used in the image forming apparatuses.

The organic electrophotosensitive material is fabricated by forming any one of the following photosensitive layers on a conductive substrate:

A single-layer photosensitive layer containing a charge generating material, charge transport material (hole transport material and/or electron transport material), and binder resin;

A multi-layer photosensitive layer in which a charge generating layer containing a charge generating material, and a charge transport layer containing a charge transport material (hole transport material and/or electron transport material) are laminated in this order or vise versa.

Unfortunately, these photosensitive layers encounter the following problems when formed directly on the conductive substrate.

(a) In a charging process during the image formation, either positive or negative electrification of a surface of the photosensitive layer will produce an electric charge of the opposite polarity thereto in the conductive substrate.

The photosensitive layer formed directly on the conductive substrate, however, is susceptible to the injection of the electric charge of the opposite polarity from the conductive substrate. If a large quantity of electric charge of the opposite polarity are injected into the photosensitive layer, the total amount of electric charge at the photosensitive layer surface is lowered.

As a result, an electrostatic latent image formed on the photosensitive layer surface in the light exposure process has a decreased potential difference between a light exposure region and a non-exposure region. This causes a printed image to sustain fogging due to the adhesion of toner particles to white areas thereof.

(b) The single-layer photosensitive layer or the lower layer of the multi-layer photosensitive layer is formed by applying a coating solution containing the above components onto the conductive substrate, followed by drying the coated film. However, the formed layer may sometimes be insufficiently bonded to the conductive substrate depending upon the type of the binder resin or the conditions for solution application, so that the formed layer is delaminated.

(c) If a surface of the conductive substrate contains a defect such as mars, the surface of the photosensitive layer formed directly on the conductive substrate will sustain a similar defect. This defect causes black spots or white spots in the formed image. Whether the defect results in the black spots or the white spots depends upon whether the image forming process adopts the normal development method or the reversal development method.

With an aim at solving these problems, there has been proposed an electrophotosensitive material wherein an intermediate layer containing a binder resin is formed on a conductive substrate, and a photosensitive layer is laid thereover.

By virtue of the intermediate layer so provided, this electrophotosensitive material is adapted to prevent the electric charge of the conductive substrate from being injected into the photosensitive layer, as well as to achieve firm bonding between the conductive substrate and the photosensitive layer, and to cover up the defect in the surface of the conductive substrate for accomplishing a smooth, defect-free surface of the photosensitive layer. Curable resins are preferably used as the binder resin in order to obtain an intermediate layer having good thermal, chemical, physical and mechanical stabilities and excellent integrity with the conductive substrate.

However, if formed from the binder resin alone, the intermediate layer has such a low conductivity that fogs tend to occur.

Specifically, in the light exposure process during the image formation, the charge generating material in the light exposure region of the photosensitive layer generates both the positive and negative electric charges The electric charge of one polarity is transported to the conductive substrate while the electric charge of the other polarity negates a charged potential at the surface of the photosensitive layer, whereby an electrostatic latent image is formed on the surface of the photosensitive layer in correspondence to a light exposure pattern.

With an intermediate layer of a low conductivity laid between the photosensitive layer and the conductive substrate, the electric charge (of the same polarity as that of the photosensitive layer surface) to be transported to the conductive substrate is blocked by the intermediate layer and thus, remains in the photosensitive layer.

Therefore, a light exposure area of the electrostatic latent image is not sufficiently lowered in potential so that fogs are prone to occur in a white area of a printed image.

Another causative factor of fogging is that because of the interference of the intermediate layer, the surface of the photosensitive layer is not sufficiently de-electrified in a charge elimination process subsequent to an image transfer process and hence, the photosensitive layer is increased in residual potential.

These problems may be solved by decreasing the thickness of the intermediate layer to the order of submicrons. However, this approach decrease the effect to cover up the defect in the conductive substrate surface for the smooth, defect-free photosensitive layer surface.

In this connection, an approach to increase the conductivity of the intermediate layer has been proposed.

For instance, Japanese Laid-open Patent Publication No. JP59-93453A (1984) has disclosed an intermediate layer containing powdery titanium oxide treated with tin oxide or alumina. Furthermore, Japanese Laid-open Patent Publication No. JP06-202366A (1994) has disclosed an intermediate layer containing titanium oxide particles having a volume resistivity of 10⁵-10⁷ Ω·cm as compacted under a predetermined compressive force.

Unfortunately, the metal oxide particles such as of titanium oxide are prone to agglomerate to form particle agglomeration while a coating solution for the intermediate layer containing such particles is applied to the conductive substrate and the resultant coated film is dried and solidified. Accordingly, the intermediate layer as a whole is improved in conductivity but varied in conductivity due to the particle agglomeration. Specifically, spots of higher conductivity and spots of lower conductivity are distributed in the intermediate layer where the electric charges are prone to be trapped in the spots of lower conductivity. Consequently, the photosensitive layer is increased in residual potential, resulting in the same problem as that caused by the intermediate layer formed from the binder resin alone.

A material capable of increasing the conductivity of the intermediate layer and less prone to form particle agglomeration is exemplified by the charge transport materials for use in the photosensitive layer.

For example, Japanese Laid-open Patent Publication No. JP06-202366A (1994) has disclosed the intermediate layer containing an electron accepting compound, whereas Japanese Laid-open Patent Publication No. JP10-73942A (1998) has disclosed an intermediate layer containing an electron attracting compound.

However, the present inventors have examined the compounds disclosed in the above official gazettes to find that the approach to improve the conductivity of the intermediate layer by admixing the above compound encounters a novel problem as below.

In order to ensure a constant thickness of the coated film, the coating solution is generally admixed with a thickener for increased viscosity. The thickener includes organic amide compounds, modified castor-oil derivatives, modified polyolefin wax compounds and organic clay derivatives.

Some of the thickeners, however, may interfere with the de-electrification by the charge transport material. That is, if an approach is taken to increase the conductivity of the intermediate layer by admixing the charge transport material thereto, this approach inhibits the admixing of the thickener to the coating solution. Without the thickener, however, the coating solution is too low in viscosity to ensure a constant thickness of the intermediate layer.

Specifically, the intermediate layer and photosensitive layer are normally formed by a dip coating method in which the conductive substrate is dipped in a coating solution for a desired layer and then withdrawn from the solution at a given rate.

For instance, when the intermediate layer is formed on the most typical tubular conductive substrate, the following procedure is taken. The tube is dipped in the coating solution, and then withdrawn therefrom with its axis maintained perpendicular to the liquid surface of the coating solution thereby coating the tube with the solution by dip coating. Subsequently, the tube withdrawn from the coating solution is heated as maintained in the above position in order to dry and solidify the coated film thereon. If the coating solution is based on a curable resin, the coated film is cured to form the intermediate layer on the tube.

However, if the coating solution is low in viscosity, the coating solution flows down on the conductive substrate while the coated film on the tube surface is dried and solidified. Because of the flow-down of the coating solution, the intermediate layer is non-uniform in thickness, being progressively decreased in thickness toward an upper end of the conductive substrate while progressively increased in thickness toward a lower end thereof in the above position.

If the intermediate layer includes a thin area having a thickness less than a predetermined value, the thin area is incapable of adequately covering up the defect in the conductive substrate surface or has a decreased effect to block the charge injection from the conductive substrate into the photosensitive layer.

If the intermediate layer includes a thick area having a thickness in excess of the predetermined value, the thick area has a lower conductivity, having a decreased function to transport the electric charge of the photosensitive layer to the conductive substrate. Therefore, the thick area cannot sufficiently de-electrify the photosensitive layer.

These are the causative factors of fogging, as described above.

With the intermediate layer being non-uniform in film thickness, the photosensitive layer cannot ensure a constant distance between its surface and the conductive substrate surface even if the photosensitive layer is laid over the intermediate layer substantially in a constant film thickness.

If an image forming apparatus with such an electrophotosensitive material mounted therein is operated for image formation, the apparatus operating on the assumption that the above distance is constant (which is normally taken for granted),the resultant image will suffer spots or the electrophotosensitive material will be decreased in durability.

A main cause of the latter problem is thought as follows. Out of the components disposed in the image forming apparatus, those in direct contact with the surface of the electrophotosensitive material, such as cleaning blade are pressed thereagainst at varied contact pressures, thus distorting the electrophotosensitive material.

Since the charge transport material also functions as the thickener, the flow-down of the coating solution may be avoided if the proportion of the charge transport material is increased to increase the viscosity of the coating solution.

However, if the charge transport material is present in excessive concentrations, the intermediate layer has such a great conductivity as to eliminate more electric charge of the photosensitive layer than required. This results in a decreased image density.

This problem may be avoided by extremely increasing the thickness of the intermediate layer. However, such a great film thickness means a correspondingly increased thickness difference. This is because the greater the film thickness, the greater the amount of coating solution flowed down. Consequently, an effect to decrease the thickness difference for ensuring the constant film thickness may not be achieved.

### SUMMARY OF THE INVENTION

It is an object of the invention to provide an electrophotosensitive material adapted to form favorable, fog-free images by virtue of an intermediate layer featuring a relatively constant film thickness as compared with the prior-art products and having an adequate, uniform conductivity.

In the pursuit of the above object, the present inventors focused on a charge transport material to be admixed to the intermediate layer. It was found that the greater the molecular weight, the greater is the ability of the charge transport material to increase the viscosity of the coating solution, provided that the mixing ratio is constant.

The present inventors have discovered the following fact through close examination of the correlation between the molecular weight of the charge transport material and the difference between the film thickness at a relatively upper area and that of a relatively lower area of the coated film when forming the intermediate layer by dip coating.

FIG. 1 graphically represents the relationship between the molecular weight of the charge transport material and the thickness difference in the intermediate layer (refer to the following description on the examples hereof for specific test conditions).

As seen from the graph, in a case where charge transport materials having molecular weights of less than 400 are used, the resultant intermediate layers have thickness differences of more than 0.7 μm. In addition, there is a tendency that as the molecular weight decreases, the intermediate layer is accordingly increased in the thickness difference.

All the charge transport materials used in the intermediate layers disclosed in the aforesaid official gazettes have molecular weights of less than 400, thus included in this category. For example, Comparative Example 4 uses a charge transport material (CT-3) of p-benzoquinone (molecular weight: 108) which is disclosed in Japanese Laid-open Patent Publication No. JP06-202366A (1994). As seen from Table 3, the intermediate layer in question has a thickness difference of as great as 1.8 μm, providing fogged images.

On the other hand, it is confirmed that where charge transport materials having molecular weights of not less than 400 are used, the resultant intermediate layers have thickness differences of less than 0.7 μm, presenting stable values on the order of 0.6 μm.

It is concluded from these facts that the use of a charge transport material having a conditional molecular weight of not less than 400 provides a coating solution increased in viscosity without excessively increasing the mixing ratio thereof, thus offering an intermediate layer featuring a relatively constant film thickness as compared with the prior art as well as an adequate, uniform conductivity.

An electrophotosensitive material according to the invention comprises a conductive substrate, an intermediate layer and a photosensitive layer, the intermediate layer and the photosensitive layer laminated on the conductive substrate in this order, wherein the intermediate layer containing a binder resin and a charge transport material having a molecular weight of not less than 400.

The invention defines the molecular weight of the charge transport material as a value determined by rounding off a result of calculation to the nearest integer, the calculation using the following atomic weights of atoms constituting the charge transport material: carbon: 12.011, hydrogen: 1.0079, oxygen: 15.999, nitrogen: 14.007.

### BRIEF DESCRIPTION OF THE DRAWING

FIG. 1 is a graphical representation of the correlation between the molecular weights of charge transport materials and the thickness differences in intermediate layers of electrophotosensitive materials fabricated in Examples 1-8 and Comparative Examples 1-13; and

FIG. 2 is a graphical representation of the correlation between the molecular weights of charge transport materials and the thickness differences in intermediate layers fabricated in Examples 9-11 and Comparative Examples 14-17.

### DETAILED DESCRIPTION OF THE INVENTION

The present invention will be described below.

Intermediate Layer

As mentioned supra, the electrophotosensitive material according to the invention comprises an intermediate layer and a photosensitive layer laminated on a conductive substrate in this order. The intermediate layer contains a binder resin and a charge transport material having a molecular weight of not less than 400.

The electron transport material capable of transporting electrons and the hole transport material capable of transporting positive holes are usable as the charge transport material.

A charge transport material adapted to transport an electric charge of the same polarity as that of an electrified surface of the photosensitive layer acts to transport the electric charge, transferred from the photosensitive layer to the intermediate layer, to the conductive substrate. On the other hand, a charge transport material adapted to transport an electric charge of the opposite polarity to that of the electrified surface of the photosensitive layer acts to transport the electric charge applied to the conductive substrate, to an inter-planar area between the intermediate layer and the photosensitive layer so as to neutralize the electric charge from the photosensitive layer. In both cases, therefore, the charge transport materials are effective to allow the intermediate layer to eliminate the electric charge of the photosensitive layer smoothly.

A usable charge transport material may be one that has a good charge transportability and a good matching with the binder resin.

Examples of a suitable electron transport material include a variety of known electron transporting compounds (electron attracting compounds) such as benzoquinone compounds, diphenoquinone compounds, naphthoquinone compounds, dinaphthoquinone compounds, malononitrile compounds, thiopyran compounds, fluorenone compounds, dinitrobenzene compounds, dinitroanthracene compounds, dinitroacridine compounds, nitroanthraquinone compounds, nitrofluorenoneimine compounds, ethylated nitrofluorenoneimine compounds, tryptanthrin compounds, tryptanthrinimine compounds, azafluorenone compounds, dinitropyridoquinazoline compounds, thioxanthene compounds, α-cyanostilbene compounds, nitrostilbene compounds, salts formed by reaction between anionic radicals of benzoquinone compounds and cations. Out of the above compounds, any one that has a molecular weight of not less than 400 may be selected as a usable charge transport material. Such materials may be used alone or in combination of two or more types.

Specific examples of the usable charge transport material include the following compounds represented by formulas (ET-1) to (ET-4), which are accompanied by molecular weights (MW), respectively:

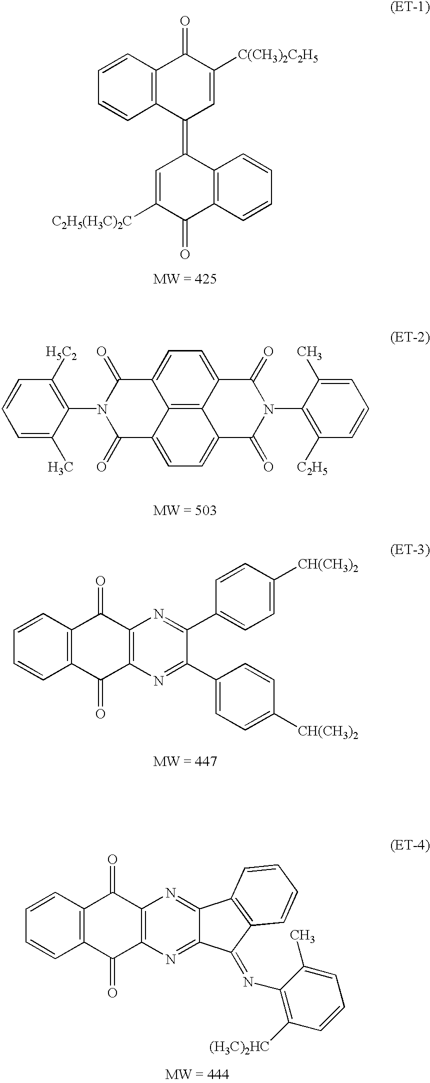

Examples of a suitable hole transport material include a variety of known hole transporting compounds such as benzidine compounds, phenylenediamine compounds, naphthylenediamine compounds, phenantolylenediamine compounds, oxadiazole compounds, styryl compounds, carbazole compounds, pyrazoline compounds, hydrazone compounds, triphenylamine compounds, indole compounds, oxazole compounds, isooxazole compounds, thiazole compounds, thiadiazole compounds, imidazole compounds, pyrazole compounds, triazole compounds, butadiene compounds, pyrene-hydrazone compounds, acrolein compounds, carbazole-hydrazone compounds, quinoline-hydrazone compounds, stilbene compounds, stilbene-hydrazone compounds, diphenylenediamine compounds and the like. Out of the above compounds, any one that has a molecular weight of not less than 400 may be selected as a usable hole transport material. Such materials may be used alone or in combination of two or more types.

Specific examples of the usable hole transport material include the following compounds represented by formulas (HT-1) to (HT-31), which are accompanied by molecular weights (MW), respectively:

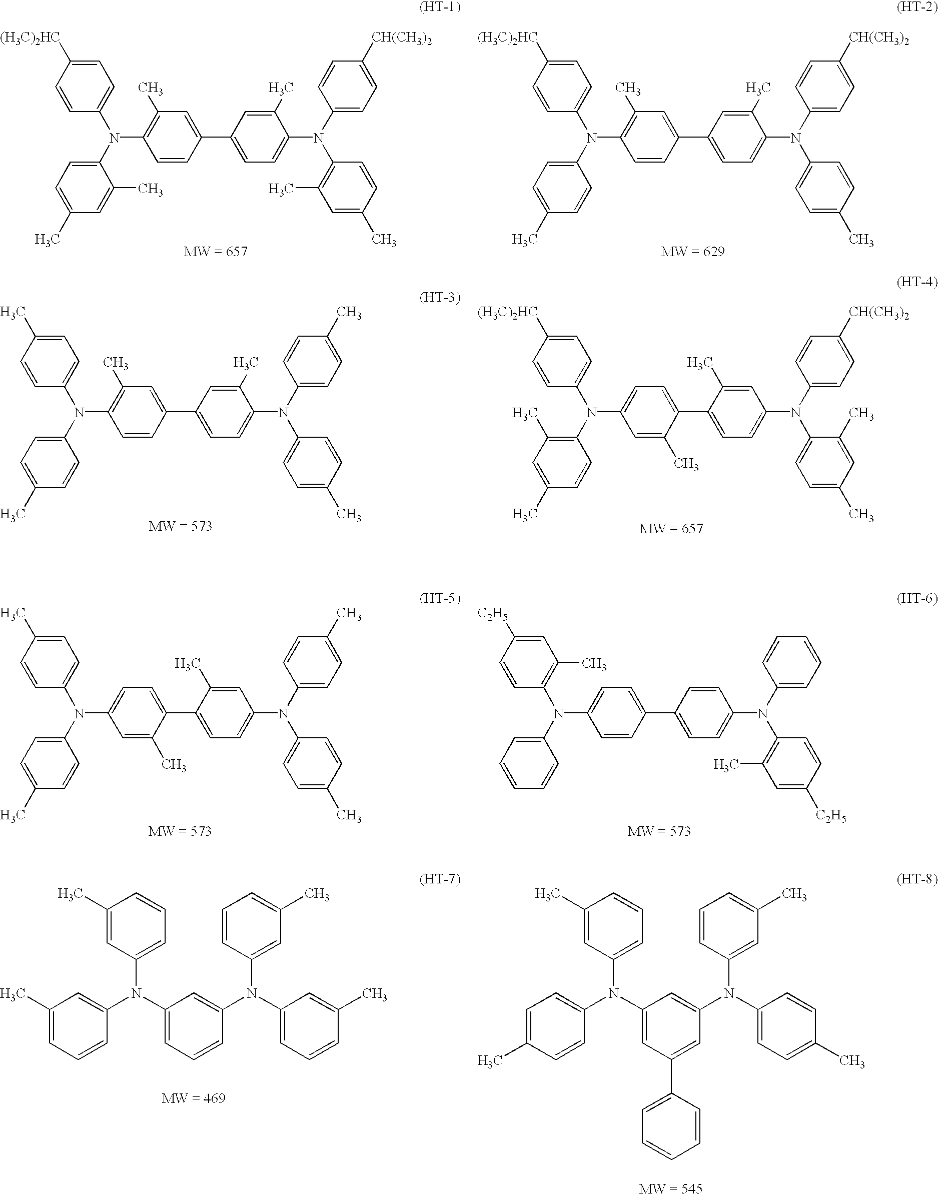

The molecular weight of the charge transport material may preferably be 1000 or less. A charge transport material having a molecular weight of 1000 or less has a good matching with the binder resin. This may result in difficulty of forming particle agglomeration in the coating solution, so that there is no possibility of causing a similar problem associated with the metal oxide particles.

The amount of the charge transport material is preferably in the range of 5 to 500 parts by weight or more preferably of 20 to 250 parts by weight based on 100 parts by weight of binder resin.

If the charge transport material is present in concentrations of 5 parts by weight and above, the mixing of the charge transport material may contribute a satisfactory effect to improve the conductivity of the intermediate layer.

If the charge transport material is present in concentrations of 500 parts by weight or less, the intermediate layer may not have too high a conductivity as described above, so that there is no possibility of the decreased image density. On the other hand, a relative proportion of the binder resin responsible for the binding force is not so decreased that the intermediate layer may be effective enough to firmly bind the photosensitive layer to the conductive substrate.

For adjustment of the charge transportability of the intermediate layer, the intermediate layer may contain, in addition to the charge transport material having a molecular weight of not less than 400, a general charge transport material having a molecular weight of less than 400 in such an amount that the effect of the invention is not decreased. The amount of such a general charge transport material may preferably be in the range of 2 to 50 parts by weight or more preferably of 5 to 30 parts by weight based on 100 parts by weight of binder resin.

The binder resin may be any of various resins conventionally used in the photosensitive layer or the intermediate layer.

Examples of a usable binder resin include thermoplastic resins such as styrene polymers, styrene-butadiene copolymers, styrene-acrylonitrile copolymers, styrene-maleic acid copolymers, acrylic polymers, styrene-acryl copolymers, polyethylene, ethylene-vinyl acetate copolymers, chlorinated polyethylene, polyvinyl chloride, polypropylene, ionomers, copolymers of vinyl chloride and vinyl acetate, polyester, alkyd resins, polyamide, polyurethane, polycarbonate, polyarylate, polysulfone, diarylphthalate resins, ketone resins, polyvinylbutyral resins, polyether resins and the like;

thermosetting resins such as silicone resins, epoxy resins, phenol resins, urea resins, melamine resins, maleic acid resins and other crosslinking thermosetting resins; and photosetting resins such as epoxy-acrylate, urethane-acrylate and the like. These resins may be used alone or in combination of two or more types.

Out of the above resins, anyone that is not dissolved in a dispersion medium (such as an organic solvent) of the coating solution for photosensitive layer to be applied on the intermediate layer may preferably be selected as a suitable binder resin.

In this regard, a resin forming a three-dimensional network in the molecule via molecular bond or ionic bond is preferred as the binder resin. Such a resin includes acrylic polymers and copolymers, alkyd resins, polyurethane, melamine resins, epoxy resins, phenol resins, urea resins, polyamide, polyester, maleic acid resins, silicone resins and the like.

These resins do not require the selection of a specific dispersion medium in the coating solution for photosensitive layer or, in other words, are insoluble to a large number of dispersion medium. Accordingly, these resins exempt the compositions of the photosensitive layer laid over the intermediate layer from restrictions imposed according to the type of dispersion medium. Hence, the freedom of function design of the electrophotosensitive material is increased.

The phenol resins, in particular, are optimal material featuring excellent integrity with the conductive substrate, solvent resistance and compatibility with the charge transport material.

The intermediate layer may contain a pigment for the purposes of adjusting the conductivity thereof and preventing the occurrence of interference fringe.

A usable pigment include known organic pigments and inorganic pigments.

Examples of a usable organic pigment include various types of phthalocyanine pigments, polycyclic quinone pigments, azo pigments, perylene pigments, indigo pigments, quinacridone pigments, azulenium salt pigments, squalilium pigments, cyanine pigments, pyrylium dyes, thiopyrilium dyes, xanthene dyes, quinoneime coloring matters, triphenylmethane coloring matters, styryl coloring matters, anthanthrone pigments, pyrylium salts, triphenylmethane pigments, threne pigments, toluidine pigments, pyrazoline pigments and the like.

Examples of a usable inorganic pigment include metal oxides such as titanium oxide (TiO₂), tin oxide (SnO₂), aluminumoxide (Al₂O₃), zinc oxide (ZnO), indium-titanium oxide, indium-tin oxide and the like; and alkaline earth metal salts such as calcium carbonate (CaCO₃), barium carbonate (BaCO₃), barium sulfate (BaSO₄) and the like.

Furthermore, there may be used the above inorganic pigments doped with antimony oxide or the like, or the above inorganic pigment particles coated with tin oxide or indium oxide, so long as such materials are not extremely low in volume resistivity.

A variety of surface treatments are applicable to the above particles so long as the particles are not extremely reduced in volume resistivity. For instance, the particles may be coated with a metal oxide film such as of aluminum, silicon, zinc, nickel, antimony, chromium and the like.

When required, the particles may be treated with a coupling agent or a surface treatment agent, such as stearic acid, organic siloxane and the like, for increased dispersibility in the binder resin or coating solution and for imparted water repellency.

The pigments may be used alone or in combination of two or more types. Above all, the metal oxides, or particularly titanium oxide, tin oxide and zinc oxide are preferred.

The mixing ratio of the pigment may preferably be in the range of 5 to 500 parts by weight or more preferably of 20 to 250 parts by weight based on 100 parts by weight of binder resin.

If the pigment is present in concentrations of less than 5 parts by weight, the mixing of the pigment may not provide a sufficient effect for adjusting the conductivity of the intermediate layer and for preventing the occurrence of interference fringe.

If the pigment is present in concentrations of more than 500 parts by weight, the pigment may produce particle agglomeration to cause the aforementioned problems.

A mean thickness of the intermediate layer is preferably in the range of 0.1 to 50 μm, or more preferably of 1 to 30 μm.

If the intermediate layer is less than 0.1 μm in thickness, the intermediate layer may be unable to attain the aforesaid effect to cover up the defect in the surface of the conductive substrate for providing the defect-free, smooth surface of the photosensitive layer. On the other hand, the intermediate layer is in excess of 50 μm in thickness, the intermediate layer may be unable to attain the aforesaid effect to ensure the constant film thickness through the decreased thickness difference.

Preparatory to the formation of the intermediate layer, a coating solution is prepared by mixing and dispersing the above components in the dispersion medium by way of the known means such as a roll mill, ball mill, attritor, paint shaker, ultrasonic disperser or the like. Then, the coating solution thus prepared is applied to the surface of the conductive substrate by means of the known solution coating method such as dip coating, blade coating, spray coating or the like, and then is dried and solidified. Where the coating solution is based on a curable resin, the applied coating solution is further cured. Thus is formed the intermediate layer. Above all, the dip coating method is most likely to suffer the drawback of producing a great thickness difference and hence, is most greatly benefited from the invention.

Any of the various known organic solvents may be used as the dispersion medium.

Examples of a usable organic solvent include alcohols such as methanol, ethanol, isopropanol, butanol and the like;

aliphatic hydrocarbons such as n-hexane, octane, cyclohexane and the like;

aromatic hydrocarbons such as benzene, toluene, xylene and the like;

halogenated hydrocarbons such as dichloromethane, dichloroethane, carbon tetrachloride, chlorobenzene and the like;

ethers such as dimethyl ether, diethyl ether, tetrahydrofuran, 1,4-dioxane, ethyleneglycol dimethyl ether, diethyleneglycol dimethyl ether and the like;

ketones such as acetone, methyl ethyl ketone, cyclohexanone and the like;

esters such as ethyl acetate, methyl acetate and the like; and

dimethylformaldehyde, dimethylformamide, dimethyl sulfoxide and the like. These solvents may be used alone or in combination of two or more types.

The coating solution may further contain a surfactant, leveling agent or the like for increasing the dispersibility of the charge transport material and pigment, and for the surface smoothness of the intermediate layer.

Conductive Substrate

The conductive substrate may employ any of those formed from various materials having conductivity. Examples of a usable conductive substrate include those formed from metals such as iron, aluminum, copper, tin, platinum, silver, vanadium, molybdenum, chromium, cadmium, titanium, nickel, palladium, indium, stainless steel, brass and the like; that formed from a plastic material on which any of the above metals is deposited or laminated; and a glass substrate coated with aluminum iodide, tin oxide, indium oxide or the like.

In short, the substrate itself may have the conductivity or the surface thereof may have the conductivity. It is preferred that the conductive substrate has a sufficient mechanical strength in use.

The conductive substrate may have any form, such as sheet, drum and the like, according to the construction of the image forming apparatus to which the conductive substrate is applied.

Photosensitive Layer

As mentioned supra, the photosensitive layer includes the single-layer type and the multi-layer type, to both of which the construction of the invention is applicable.

Examples of a suitable charge generating material contained in the single-layer photosensitive layer or the charge generating layer of the multi-layer photosensitive layer include powders of inorganic photoconductive materials such as selenium, selenium-tellurium, selenium-arsenic, cadmium sulfide, amorphous silicon, amorphous carbon and the like; and a variety of known pigments including phthalocyanine pigments comprising crystalline phthalocyanine compounds of various crystalline forms such as metal-free phthalocyanine, titanyl phthalocyanine and the like; azo pigments, bisazo pigments, perylene pigments, anthanthrone pigments, indigo pigments, triphenylmethane pigments, threne pigments, toluidine pigments, pyrazoline pigments, quinacridone pigments, dithioketopyrolopyrrole pigments and the like.

The charge generating materials may be used alone or in combination of two or more types such that the photosensitive layer may have sensitivity at a desired wavelength range.

Particularly, an electrophotosensitive material having photosensitivity in the wavelength range of 700 nm or more is required by digital-optical image forming apparatuses such as laser beam printers, plain paper facsimiles and the like which utilize infrared light such as semiconductor laser beam. Therefore, out of the above exemplary compounds, the phthalocyanine pigments are preferably employed as the charge generating material.

The charge transport material and the binder resin may each employ the same as those exemplified in the description of the intermediate layer and be used in combination according to the composition or the like of the photosensitive layer. It is noted that the charge transport material is not limited to those having a molecular weight of not less than 400 and may be one having a smaller molecular weight than the above.

In addition to the above components, the photosensitive layer may further contain any of the various additives such as a fluorene compound, ultraviolet absorber, plasticizer, surfactant, leveling agent and the like. For an increased sensitivity of the electrophotosensitive material, there may be further admixed a sensitizer such as terphenyl, halonaphthoquinone, acenaphthylene or the like.

The single-layer photosensitive layer may preferably contain the charge generating material in concentrations of 0.1 to 50 parts by weight or particularly 0.5 to 30 parts by weight based on 100 parts by weight of binder resin.

Where either the hole transport material or the electron transport material is used as the charge transport material, the single-layer photosensitive layer may preferably contain the selected charge transport material in concentrations of 5 to 500 parts by weight or particularly 25 to 200 parts by weight based on 100 parts by weight of binder resin.

Where the charge transport material is comprised of the combination of the hole transport material and the electron transport material, these transport materials may be present in total concentrations of 20 to 500 parts by weight or particularly 30 to 200 parts by weight based on 100 parts by weight of binder resin.

The thickness of the single-layer photosensitive layer may preferably be in the range of 5 to 100 μm or particularly 10 to 50 μm.

The charge generating layer of the multi-layer photosensitive layer may either comprise the charge generating material alone or a dispersion of the charge generating material and, if required, a charge transport material of one polarity in the binder resin. In the latter composition, the charge generating material may preferably be present in concentrations of 5 to 1000 parts by weight or particularly 30 to 500 parts by weight based on 100 parts by weight of binder resin while the charge transport material may preferably be present in concentrations of 1 to 200 parts by weight or particularly 5 to 100 parts by weight based on 100 parts by weight of binder resin.

The charge transport layer of the multi-layer photosensitive layer may comprise the charge transport material of the opposite polarity to that of the charge transport material comprising the charge generating layer. In this case, the charge transport material may preferably be present in concentrations of 10 to 500 parts by weight or particularly 25 to 200 parts by weight based on 100 parts by weight of binder resin.

Furthermore, the charge transport layer may include both the hole transport material and the electron transport material. In this case, these transport materials may preferably be present in total concentrations of 20 to 500 parts by weight or particularly 30 to 200 parts by weight based on 100 parts by weight of binder resin.

In this case, the charge generating layer may be free of the charge transport material or may contain both types of the charge transport materials or either one of these.

As to the thickness of the multi-layer photosensitive layer, that of the charge generating layer may preferably range from about 0.01 to 5 μm or particularly about 0.1 to 3 μm whereas that of the charge transport layer may preferably range from about 2 to 100 μm or particularly about 5 to 50 μm.

A barrier layer containing a binder resin may be formed between the conductive substrate and the intermediate layer, between the organic photosensitive layer of the single-layer type or of the multi-layer type and the intermediate layer, or between the charge generating layer and the charge transport layer constituting the multi-layer photosensitive layer.

The barrier layer is formed for the purposes of increasing the ease of application of the coating solution to the conductive substrate or the aforesaid undercoat layer, preventing the penetration of the coating solution into the undercoat layer, improving the fast-dry property of the coated film, increasing the adhesion between layers, and enhancing the electrophotographic characteristics (resistance to fog and density variations, and durability).

Examples of a suitable binder resin for forming the barrier layer include water-soluble resins such as polyvinyl alcohol, polyvinyl pyridine, polyvinyl pyrrolidone, polyethyleneoxide, polyacrylic acids, methyl cellulose, ethyl cellulose, polyglutamic acids, casein, gelatin, starches and the like; and

polyamide resins, phenol resins, polyvinyl formal, alkyd resins and the like.

The thickness of the barrier layer may be in such a range as not to decrease the characteristics of the electrophotosensitive material or not to interfere with the electric charge transport in each layer.

The photosensitive layer may be formed with a protective layer on its surface.

### EXAMPLES

The invention will hereinbelow be described with reference to examples and comparative examples thereof.

### Example 1

Forming Intermediate Layer

A ball mill was operated for 24 hours for mixing and dispersing the following ingredients along with zirconia beads having a diameter of 1 mm thereby preparing a coating solution for intermediate layer.

Binder resin: 60 parts by weight of phenol resin (TD447 available from Dainippon Ink & Chemicals Inc.)

Charge transport material: 20 parts by weight of compound represented by the formula ET-1 (MW: 425)

Dispersion medium: 100 parts by weight of methanol

An aluminum tube having a diameter of 30 mm was retained by a retainer capable of holding the tube as enclosing an interior thereof and positioned above a liquid surface of the coating solution with its axis oriented perpendicular to the liquid surface.

The retainer was lowered at a rate of 5 mm/sec to dip the whole body of the tube in the coating solution and was halted in this state for 3 seconds. Subsequently, the retainer was elevated at a rate of 5 mm/sec to withdraw the whole body of the tube from the coating solution. Thus, the coating solution was dip coated over an outer periphery of the tube.

Then, as maintained in the above position, the tube was subjected to 30-minute heating at 150° C. for drying and solidifying the coated film and curing the resin. Thus was obtained an intermediate layer having a mean thickness of 10 μm.

Forming Charge Generating Layer

The following two ingredients were dispersed using a ultrasonic disperser.

Pigment: 1 part by weight of Y-type titanyl phthalocyanine

Dispersion medium: 39 parts by weight of ethyl cellosolve

A solution comprising the following two components was dispersed in the resultant dispersion liquid by means of the ultrasonic disperser. Thus was prepared a coating solution for charge generating layer.

Binder resin: 1 part by weight of polyvinylbutyral (BM-1 available from Sekisui Chemical Co., Ltd.)

Dispersion medium: 9 parts by weight of ethyl cellosolve

The resultant coating solution was dip coated on the above intermediate layer. The coated film was dried and solidified by 5-minute heating at 110° C. Thus was formed a charge generating layer having a thickness of 0.5 μm.

Forming Charge Transport Layer

A coating solution for charge transport layer was prepared by mixing and dispersing the following ingredients.

Electron transport material: 0.05 parts by weight of 3,3′,5,5′-tetra-tert-butyl-4,4′-diphenoquinone

Hole transport material: 0.8 parts by weight of N,N,N′,N′-tetrakis(3-methylphenyl)1,3-diaminobenzene

Binder resin: 0.95 parts by weight of Z-type polycarbonate (available as “Panlite TS2050” from Teijin Chemicals Ltd.), and

0.05 parts by weight of polyester resin (RV200 available from TOYOBO CO., LTD.)

Dispersion medium: 8 parts by weight of tetrahydrofuran

The resultant coating solution was dip coated on the charge generating layer. The coated film was dried and solidified by 30-minute heating at 110° C. thereby to form a charge transport layer having a thickness of 30 μm.

Thus was fabricated an electrophotosensitive material of Example 1 wherein the multi-layer photosensitive layer was laid over the intermediate layer.

### Examples 2 to 8

Electroelectrophotosensitive materials of Examples 2 to 8 were each fabricated the same way as in Example 1, except that the compound of the formula (ET-1) as the charge transport material was replaced by the same amount of a compound listed in Table 1.

TABLE 1

| | C.T.M. | MW |
|---|---|---|
| EX. 1 | ET-1 | 425 |
| EX. 2 | HT-7 | 469 |
| EX. 3 | HT-8 | 545 |
| EX. 4 | HT-3 | 573 |
| EX. 5 | HT-10 | 653 |
| EX. 6 | HT-1 | 657 |
| EX. 7 | HT-18 | 701 |
| EX. 8 | HT-20 | 751 |

The term “charge transport material” is abbreviated as “C.T.M.” in Tables and drawings.

### Comparative Example 1

An electrophotosensitive material of Comparative Example 1 was fabricated the same way as in Example 1, except that a coating solution for intermediate layer was free of a charge transport material.

### Comparative Examples 2 to 13

Electroelectrophotosensitive materials of Comparative Examples 2 to 13 were each fabricated the same way as in Example 1, except that the compound of the formula (ET-1) as the charge transport material was replaced by the same amount of a compound listed in Table 2.

TABLE 2

| | C.T.M. | MW |
|---|---|---|
| C. EX. 1 | Absent | — |
| C. EX. 2 | CT-1 | 79 |
| C. EX. 3 | CT-2 | 86 |
| C. EX. 4 | CT-3 | 108 |
| C. EX. 5 | CT-4 | 120 |
| C. EX. 6 | CT-5 | 124 |
| C. EX. 7 | CT-6 | 128 |
| C. EX. 8 | CT-8 | 162 |
| C. EX. 9 | CT-7 | 182 |
| C. EX. 10 | CT-9 | 245 |
| C. EX. 11 | CT-12 | 324 |
| C. EX. 12 | CT-11 | 338 |
| C. EX. 13 | CT-10 | 368 |

The symbols in the table represent the following compounds, respectively.

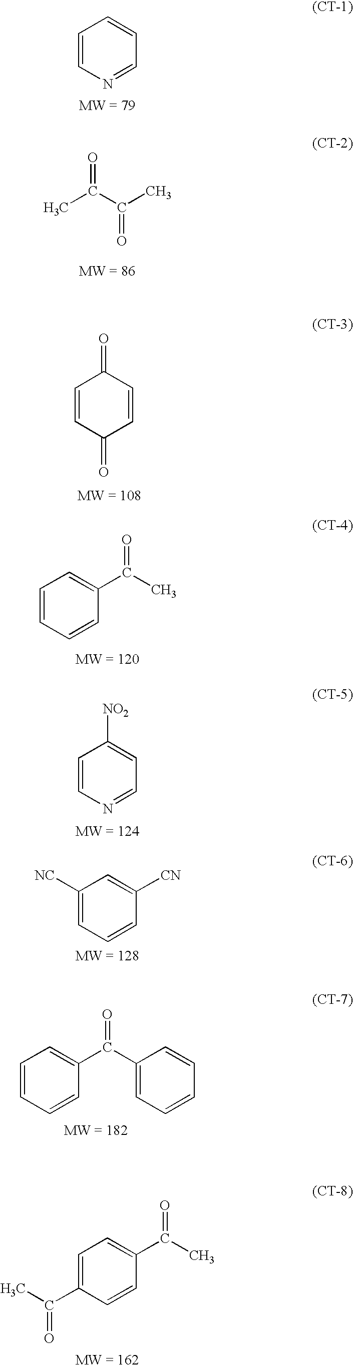

In the above examples and comparative examples, a contact eddy current probe type coating thickness tester was used to take measurement on the thickness of each intermediate layer prior to the formation of the multi-layer photosensitive layer laminated on the intermediate layer. Thickness readings were made at an outer circumference 20 mm below an upper end of the tube and at an outer circumference 20 mm above an lower end thereof, respectively, the upper end and the lower end of the tube decided based on the position of the tube subjected to the solution coating and drying processes. More specifically, thickness readings were made at 12 points along each of the above outer circumferences (300 intervals) three times per point. A mean value of thickness at each circumference was determined from above 36 measurements.

The thickness difference ΔT (μm) in the intermediate layer was determined based on the following expression (I) using the mean values at the upper and lower circumferences:

ΔT=(T1−T2) (I)

wherein T1 denotes the mean value (μm) of thicknesses at the circumference 20 mm above the lower end of the tube subjected to the solution coating and drying processes, whereas T2 denotes the mean value (μm) of thicknesses at the circumference 20 mm below the upper end thereof.

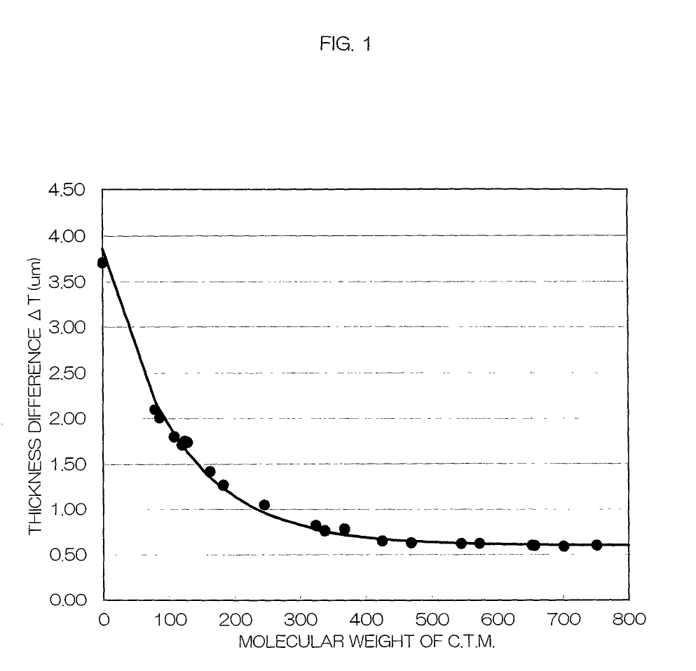

The results are listed in Table 3. FIG. 1 shows the relationship between the molecular weights of the charge transport materials and the thickness differences in the intermediate layers ΔT (μm).

Image Evaluation

The electrophotosensitive materials of the examples and comparative examples were each mounted in an internal unit of a laser beam printer (LBP-450 available from CANON INC.) for continuous production of 10 prints of a black and white stripe image. The tenth print was visually inspected for fogs at white areas thereof. The degree of fogs was evaluated based on the following three levels:

◯: No fogs observed;

Δ: Fogs found only through close observation; and

X: Obviously heavy fogs.

The results are listed in Table 3.

TABLE 3

| | C.T.M. | MW | ΔT (μm) | Fogs |
|---|---|---|---|---|
| C. EX. 1 | Absent | — | 3.71 | x |
| C. EX. 2 | CT-1 | 79 | 2.10 | x |
| C. EX. 3 | CT-2 | 86 | 2.01 | x |
| C. EX. 4 | CT-3 | 108 | 1.80 | Δ |
| C. EX. 5 | CT-4 | 120 | 1.71 | Δ |
| C. EX. 6 | CT-5 | 124 | 1.75 | Δ |
| C. EX. 7 | CT-6 | 128 | 1.74 | Δ |
| C. EX. 8 | CT-8 | 162 | 1.42 | Δ |
| C. EX. 9 | CT-7 | 182 | 1.27 | Δ |
| C. EX. 10 | CT-9 | 245 | 1.05 | Δ |
| C. EX. 11 | CT-12 | 324 | 0.82 | Δ |
| C. EX. 12 | CT-11 | 338 | 0.76 | Δ |
| C. EX. 13 | CT-10 | 368 | 0.78 | Δ |
| EX. 1 | ET-1 | 425 | 0.65 | ∘ |
| EX. 2 | HT-7 | 469 | 0.63 | ∘ |
| EX. 3 | HT-8 | 545 | 0.62 | ∘ |
| EX. 4 | HT-3 | 573 | 0.62 | ∘ |
| EX. 5 | HT-10 | 653 | 0.60 | ∘ |
| EX. 6 | HT-1 | 657 | 0.60 | ∘ |
| EX. 7 | HT-18 | 701 | 0.59 | ∘ |
| EX. 8 | HT-20 | 751 | 0.60 | ∘ |

As seen from Table 3 and FIG. 1, all the electrophotosensitive materials of Examples 1 to 8 have the thickness differences in the intermediate layer ΔT of not more than 0.7 μm or on the order of 0.6 μm. It was thus determined that the constant thickness of the intermediate layer can be achieved by using a compound of a molecular weight of not less than 400 as the charge transport material. In addition, it was determined from Table 3 that the electrophotosensitive materials of the examples are all capable of providing favorable, fog-free images.

### Examples 9 to 11 and Comparative Examples 14 to 17

Coating solution for intermediate layer of Examples 9 to 11 and Comparative Examples 14 to 17 were each prepared the same way as in Example 2, 4, 8, Comparative Example 1, 5, 10 and 13 except that the phenol resin (TD447) as the binder resin was replaced by the same amount of a phenol resin (J325 available from Dainippon Ink & Chemicals Inc.).

Then, intermediate layer of the examples and comparative examples were each fabricated the same way as in Example 1 except that the retainer was elevated at a rate of 4 mm/sec to withdraw the tube from the coating solution. Thus was obtained an intermediate layer having a mean thickness of 4.5 μm.

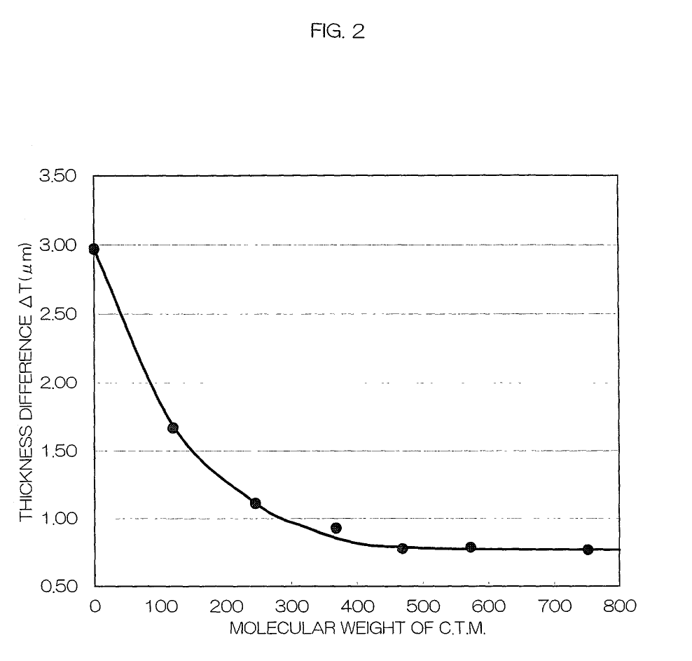

The thickness difference ΔT (μm) in the intermediate layer of the examples and comparative examples was determined to the same measurement as mentioned above. The results are listed in Table 4. FIG. 2 shows the relationship between the molecular weights of the charge transport materials and the thickness differences in the intermediate layers ΔT (μm).

TABLE 4

| | C.T.M. | MW | ΔT (μm) |
|---|---|---|---|
| C. EX. 14 | Absent | — | 2.97 |
| C. EX. 15 | CT-4 | 120 | 1.67 |
| C. EX. 16 | CT-9 | 245 | 1.11 |
| C. EX. 17 | CT-10 | 368 | 0.93 |
| EX. 9 | HT-7 | 469 | 0.78 |
| EX. 10 | HT-3 | 573 | 0.79 |
| EX. 11 | HT-20 | 751 | 0.77 |

As seen from Table 4 and FIG. 2, all the electrophotosensitive materials of Examples 9 to 11 have the thickness differences in the intermediate layer ΔT of not more than 0.8 μm. It was thus determined that the constant thickness of the intermediate layer can be achieved by using a compound of a molecular weight of not less than 400 as the charge transport material.

What we claim is:

1. An electrophotosensitive material comprising an intermediate layer and a photosensitive layer, the intermediate layer and the photosensitive layer laminated on the conductive substrate in this order,
wherein the intermediate layer containing a binder resin and a charge transport material having a molecular weight of not less than 400.

2. The electrophotosensitive material according to claim 1, wherein the molecular weight of the charge transport material is not more than 1000.

3. The electrophotosensitive material according to claim 1, wherein the binder resin is a phenol resin.

4. The electrophotosensitive material according to claim 1, wherein the charge transport material is present in concentrations of 5 to 500 parts by weight based on 100 parts by weight of binder resin.

5. The electrophotosensitive material according to claim 1, wherein the intermediate layer contains a pigment.

6. The electrophotosensitive material according to claim 5, wherein the pigment is a metal oxide.

7. The electrophotosensitive material according to claim 1, wherein the intermediate layer has a mean thickness of 0.1 to 50 μm.

8. The electrophotosensitive material according to claim 1, wherein the photosensitive layer is a single-layer photosensitive layer containing a charge generating material, charge transport material and binder resin.

9. The electrophotosensitive material according to claim 1, wherein the photosensitive layer is a multi-layer photosensitive layer comprising a charge generating layer containing a charge generating material, and a charge transport layer containing a charge transport material.
